(19) United States
(12) Patent Application Publication
(10) Pub. No.: US 2005/0268790 A1
(43) Pub. Date: Dec. 8, 2005

(54) Apparatus for the production of espresso coffee and the like

(75) Inventor: Francesco Baldacci, Florence (IT)

Correspondence Address: Grant E. Pollack, Esq.;POLLACK, P.C., The Chrysler Building, 132 East 43rd Street, Suite 760, New York, NY, 10017, US

(73) Assignee: Bialetti Industrie S.p.A.

(21) Appl. No.: 11/146,760

(22) Filed: May 28, 2005

(30) Foreign Application Priority Data
May 28, 2004 (IT) FI2004A000121

(51) Int. Cl. A23F 3/00

(52) U.S. Cl. 99/285

(57) ABSTRACT

An apparatus for the production of espresso coffee and the like is disclosed. The apparatus includes a lower vessel having an inlet opening, a substantially funnel-shaped intermediate vessel placed axially at the inlet opening to the lower vessel, and an electric heater in the lower vessel for heating water contained therein. The intermediate vessel comprises at least a perforated plate that defines a chamber for containing coffee in a finely ground or powder form. An upper vessel is mounted axially to the lower vessel in a desirable fashion and in communication with the lower vessel through the intermediate vessel. The intermediate vessel is reversibly connected to the lower vessel in a relatively tight fashion relative to the outside. The lower vessel is hydraulically connected to a water reservoir through a pump. The water reservoir is positioned alongside the lower vessel and on the same support. Water is fed into the lower vessel in close proximity to the heater. Further provided are valves for controlling the pressure of the heated water and/or coffee produced, whereby dispensing coffee in the upper vessel occurs only when the water and/or coffee pressure reaches a predetermined value.

### FIELD OF THE INVENTION

The present invention relates to an electric coffee maker for the production of espresso coffee.

### DESCRIPTION OF THE PRIOR ART

The traditional coffee maker for domestic use, of the type commonly known as moka or mocha, is formed by a lower vessel and an upper vessel generally screwed axially and tightly one to the other and communicating via an intermediate, substantially funnel-shaped vessel having a tubular portion. An axial duct, open at the upper end and if necessary provided with a dispensing member, extends from the base of the upper vessel. The coffee powder is placed in the intermediate vessel, while the lower vessel, which acts as a boiler, is filled with water as far as a preset level. The formation of steam in the boiler following the administering of heat causes an increase in pressure therein, sufficient for causing the hot water to rise up along the tubular portion of the intermediate vessel, forcing it to diffuse in the layer of coffee powder, traversing it and rising up along the axial duct of the upper vessel so as to pour into it, flowing from its free end.

In this type of domestic coffee maker the working pressure of the hot water that traverses the layer of coffee powder is generally very low and, since it is limited by a safety valve, the pressure drop through the layer of coffee powder cannot go beyond certain values. The low pressure of the hot water is responsible for the incomplete process of infusion whose effect influences the properties of the coffee produced.

Conventional domestic coffee makers generally use an external source of heat, for example a gas or other fuel cooker or an electric plate, although small coffee makers for domestic use with electrical heating are becoming increasingly widespread, that is to say coffee-makers provided with their own dedicated electric heater, in some cases integral with the boiler and in others separable therefrom. The success of electric coffee makers is due above all to their greater versatility of use, as they allow coffee to be prepared anywhere, even where a cooker is not available, for example in a bedroom or an office and, in the portable version, also in a car.

From the standpoint of the properties of the coffee produced, both traditional domestic coffee makers and those associated with dedicated electrical heating means, have the limitation, as referred previously, of not allowing preparation of real espresso coffee such as that which can be produced with professional machines for use in bars or also with espresso coffee makers for domestic use. The production of espresso coffee requires, as is known, in addition to a very fine grain size of the coffee powder used, also careful control of the temperature and pressure inside the boiler. In order to obtain the correct density of the infusion, it is important that diffusion of the water in the layer of coffee powder is as complete as possible and takes place at a constant temperature and for a preset time. These conditions cannot be observed in conventional domestic machines of the moka type wherein the contact time and the diffusion within the layer of coffee powder are controlled solely by the pressure of the steam which is formed in the boiler and which is responsible for the flow of hot water intended to traverse the layer of coffee powder.

In known machines for the production of espresso coffee, both domestic and professional, the pressure of the hot water inside the boiler is provided by a pump which feeds it over a filter filled with coffee powder and enclosed in a filter holder. The pressure of the water, associated with the finer grain size of the powder and a smaller section of the holes of the filtering plate, allows a more intense infusion process whereby the substances contained in the coffee powder, which confer to the infusion the typical properties of espresso coffee, are almost completely extracted.

On the other hand, for a number of reasons, including their simplicity of use and their established customary use, domestic moka coffee makers continue to be preferred over domestic machines for espresso coffee, despite the fact that the former do not succeed in achieving the typical quality features of espresso coffee. Their bulk in particular is considered to be one disadvantage of domestic machines for espresso coffee, which means they must be kept always on view on some furniture unit, and the fact that they traditionally do not allow preparation of more than two servings of coffee simultaneously, and therefore force replacement of the powder for each cup, or at most two cups, of coffee produced, whereas in moka coffee makers, according to their size, a much larger number of cups of coffee can be made.

### OBJECTS AND SUMMARY OF THE INVENTION

Therefore, the main object of the present invention is to provide a coffee maker for domestic use which has the structure of a moka coffee maker yet which enables coffee infusions to be made with the typical properties of espresso coffee.

A particular object of the present invention is to provide a coffee maker of the type mentioned above which is small in size and, in any case, only slightly larger in size than a traditional moka coffee maker.

Another object of the present invention is to provide a coffee maker of the type mentioned above which allows the production of several servings of espresso coffee.

A further object of the present invention is to provide a coffee maker of the type mentioned above wherein the ordinary maintenance operations (washing of the boiler and coffee collecting vessel, and emptying the used coffee powder) are simple and fast and the risks of soiling for the user and worktops are minimised.

The basic features of the coffee maker for domestic use according to the present invention are claimed in claim 1. Further important features are claimed in the dependent claims.

### BRIEF DESCRIPTION OF THE DRAWINGS

These and other features, and advantages, of the coffee maker for domestic use according to the present invention will be made clearer by the following description of some embodiments thereof, given by way of a non-limiting example with reference to the accompanying drawings, wherein:

FIG. 1 is an elevational sectional view of a first embodiment of the coffee maker according to the invention;

FIG. 2 is a partially sectioned top plan view from above of the coffee maker of FIG. 1;

FIG. 3 is a sectioned view of the coffee maker of FIG. 1 along line III-III of FIG. 2;

FIG. 4 is a partial elevational sectional view of a variation of the coffee maker of FIG. 1;

FIG. 5 is an enlarged section of detail A of FIG. 4;

FIG. 6 is a detail view of a releasable coupling for connection of the water supply line to the boiler of the coffee maker of FIG. 1;

FIG. 7 is an elevational sectional view of a second embodiment of the coffee maker according to the invention;

FIG. 8 is a partial cross sectional view along line VIII-VIII of FIG. 7;

FIG. 9 is an axial sectional view along line IX-IX of FIG. 7;

FIG. 10 is an elevational sectional view of a third embodiment of the coffee maker according to the invention.

### DESCRIPTION OF THE PREFERRED EMBODIMENTS

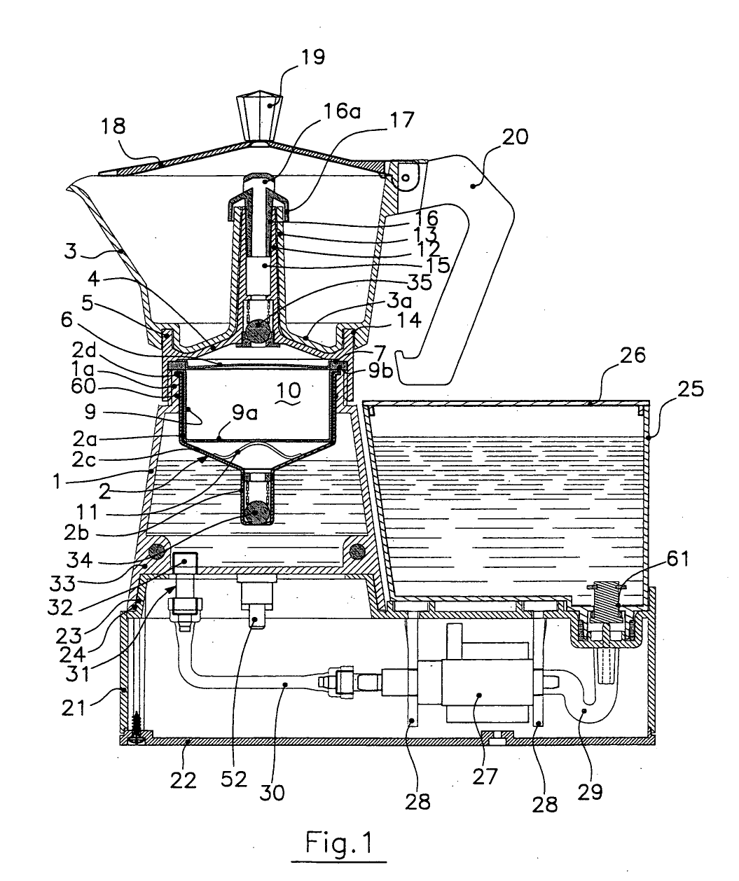

Referring to FIGS. 1, 2 and 3, the domestic coffee maker for producing espresso coffee according to the invention comprises a lower vessel 1 or boiler, an intermediate, substantially funnel shaped vessel 2 suitable for holding the coffee powder and tightly connected to the boiler 1 at its inlet, and an upper vessel 3 for collecting the coffee infusion, arranged coaxially to the boiler 1 and to the intermediate vessel 2. More specifically the intermediate vessel 2 has a cylindrical portion 2a and a tubular portion 2b joined one to the other by a truncated cone portion 2c, the tubular portion 2b extending axially towards the bottom wall of the boiler 1. The inlet of the boiler 1 is defined by a tubular wall 1a whereto the cylindrical portion 2a is connected tightly by means of an O ring 60. A small perimetric edge 2d projecting from the cylindrical portion rests on the edge of the tubular wall 1a.

A disk-shaped body 4 extends above the intermediate vessel 2 and is bordered around its perimeter by a sleeve edge 5 which is screwed externally to the tubular wall 1a. The disk 4 has a substantially conical shape slanting towards the upper vessel 3 above, and on the side of the intermediate vessel 2 holds a filtering plate 6 attached by means of an annular seal 7 engaged in a groove 8 formed on the internal face of the sleeve 5 immediately below the disk 4. The seal 7, in an elastic material, creates the hermetic tightness of the boiler 1 once the tubular sleeve 5 is screwed fully to the tubular wall 1a of the boiler 1.

Inside the cylindrical portion 2a of the intermediate vessel 2 a container 9 is placed, with a finely perforated base 9a which, together with the filtering plate 6, defines a chamber 10 for containing the coffee powder. The container for the coffee powder 9 has a small projecting perimeter edge 9b which is placed between the seal 7 and the corresponding small edge 2d of the intermediate vessel 2 when the sleeve 5 is completely screwed to the tubular wall 1a of the boiler 1, in this way securing the container 9 inside the intermediate vessel 2.

An elastic element 11 is provided inside the truncated cone portion 2c of the intermediate vessel 2. The elastic element 11 is placed between the truncated cone walls of portion 2c and the bottom wall 9a of the coffee powder container 9. The elastic element 11 is compressed by the base 9a when the sleeve 5 is fully screwed to the tubular wall 1a, so that, when said sleeve is unscrewed and removed, the elastic reaction of the elastic element 11 pushes the container 9 axially, making it project partially from the intermediate vessel 2 and thus facilitating its grip for subsequent extraction and removal of the used coffee powder. Moreover raising of the container 9 creates a vacuum in the part below it which draws the water located between the disk 4 and the surface of the coffee powder. This water, mixed with coffee powder, would otherwise inevitably flow to the outside, when the disk-shaped body 4 is unscrewed from the lower vessel 1.

A first tubular element 12 extends axially from the centre of the disk 4 inside the upper vessel 3 and a second tubular element 13, extending coaxially from the bottom wall 3a of the upper vessel 3, engages slidingly on the first tubular element 12. The base 3a rests on the disk 4, with the same configuration and slant, and along its perimeter a groove 14 is formed, wherein the tubular sleeve 5 engages, in this way removably securing the upper vessel 3 to the boiler 1.

The tubular element 12, which extends from the disk 4, defines a duct 15 ending with a flared portion in which a truncated cone bush 16 is engaged, with the same slant, ending with a radially perforated head 16a through which the coffee produced can flow. A skirt 17 extends radially from the bush 16, immediately below its perforated head 16a, and around the tubular element 13 at its free end. The bush 16, forming a watertight connection with the tubular element 12 due to the conicity of the respective reciprocal contact walls, prevents infiltration of the coffee infusion between the upper vessel 3 and the disk 4, assisted for this purpose also by the skirt 17 which covers the free ends of the two tubular elements 12 and 13.

The upper vessel 3 is provided, as is customary, with a lid 18, with a central knob 19 for its raising, and a side handle 20.

The lower vessel 1 is mounted on a box-shaped body 21 provided with a removable base 22. More specifically the box-shaped body 21 has a raised portion 23 which engages in a corresponding cavity 24 formed on the base of the lower vessel 1. A water reservoir 25, with a removable lid 26, is also positioned on the box-shaped body 21, alongside the lower vessel 1. Inside the box-shaped body 21 a pump 27 is placed, supported by elastic vibration-preventing supports 28 and connected to the reservoir 25 via a suction duct 29 and to the boiler 1 via a discharge duct 30. The connection between the duct 29 and the base of the reservoir 25 is formed by means of a valve 61 suitable for preventing the release of water from the reservoir when the latter is disengaged from the duct 29 so as to be removed from the box-shaped body 21, for example for cleaning. The discharge duct 30, in the present embodiment of the invention, is instead connected to the boiler 1 via a fixed coupling joint 31, so that the boiler 1 is integral with the box-shaped body 21 and can be separated therefrom only by accessing its interior and adjusting a connection ring nut. The joint 31 is connected to a release nozzle 32 situated on the bottom wall of the boiler 1, wherefrom the cold water flows out, preferably tangentially to the base of the boiler so as to eliminate, or at least limit, turbulence phenomena. In the present embodiment of the invention the water is heated by means of an electrical resistor 33 embedded in the metal of the boiler 1 on the bottom wall thereof and the temperature is controlled by means of a thermostat 52.

The coffee maker according to the invention is also provided with a control panel, not shown, formed for example frontally on the box-shaped body 21 and provided with all the pushbuttons and the operation indicators required for operative control of the coffee maker.

When using the coffee maker according to the invention, after having filled with water the reservoir 25 and the boiler up to the level indicated therein, and after having placed the coffee powder in the container 9, the chamber 10 is closed by screwing the disk 4 to the boiler 1 and positioning the upper reservoir 3 above it. The heating device is then switched on and remains in operation until the temperature of the water has reached the preset value (generally around 95° C.). At this point the user, by pressing the pushbutton for starting the pump 27, causes water to flow into the boiler 1 which forces the hot water into the tubular portion 2b, making it pass through the layer of coffee powder and from there rise up through the duct 15 until it flows out into the upper vessel 3. The user will keep the pump 27 in operation until the level in the upper vessel 2 has risen to the level corresponding to the servings required. Preferably, for a direct check of the level in the upper vessel 3, the latter will be made of a transparent material and a scale indicating the servings which correspond to the level reached by the coffee infusion will be provided on the vessel wall.

In order to ensure that the hot water traverses the layer of coffee powder at an optimal pressure (generally around 2-4 bars, according to the degree of compression of the powder and its grain size), a valve 34 is placed inside the tubular portion 2b of the intermediate vessel 2, illustrated by way of an example in the form of a rubber ball forced elastically against the aperture for access to the tubular portion 2b. This valve avoids the pulsed feed of hot water at low pressure through the layer of coffee powder before the start of the pump. A further valve 35, also illustrated by way of an example in the same way as the valve 34, is provided at the inlet of the duct 15 with the triple function of ensuring discharge of the coffee infusion only after the pressure in the chamber 10 has reached a preset value sufficient for providing an optimal water-powder contact time, of forming in the duct 15 an orifice with restricted section for causing turbulence in the flow of liquid and with formation of the typical cream of espresso coffee, and finally of preventing the residual coffee remaining in the duct 15 from flowing out therefrom when the coffee maker is disassembled for cleaning.

Whereas the valve 35 is considered essential for the multiple functions it is called on to perform, the valve 34 is not strictly necessary for controlling the pressure inside the boiler. Although with a limited loss of working flexibility, this control too can be assigned to the valve 35. In this case the hot water gradually fills the intermediate vessel as the pump feeds cold water into the lower vessel and dispensing of the coffee infusion only starts when the pressure of the infusion above the coffee powder exceeds the calibration pressure of the valve 35.

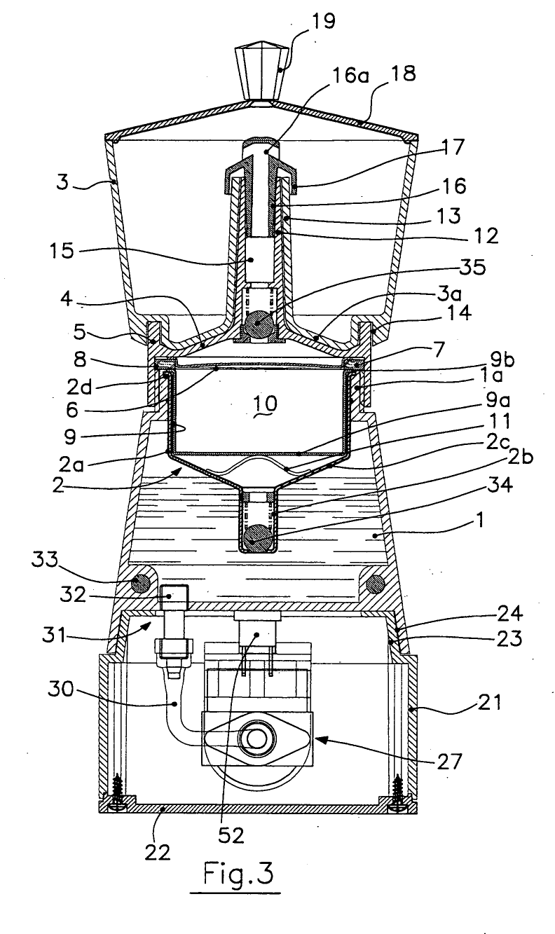

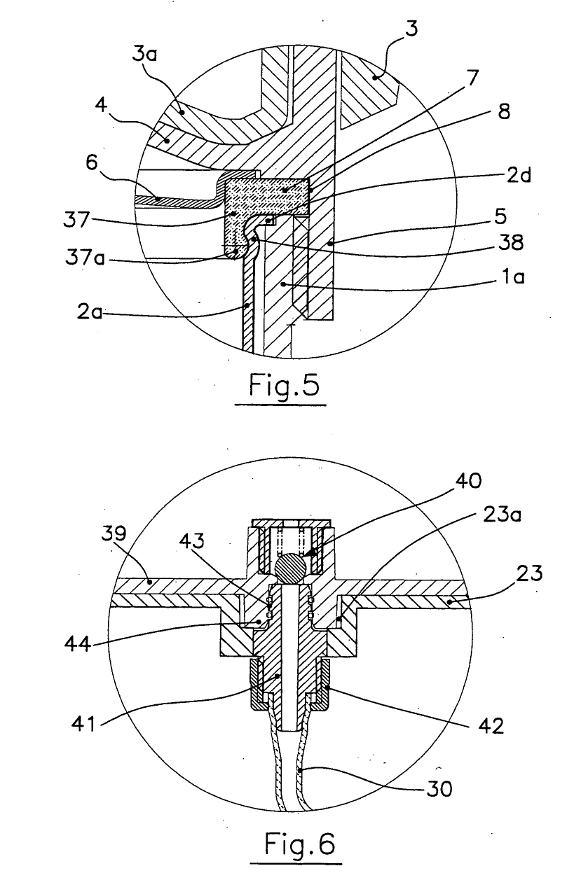

FIGS. 4 and 5 show a variation of the coffee maker according to the invention. In these figures, the components identical to those of the embodiment previously described and illustrated will be denoted by the same reference numerals and will not be described again. The variation illustrated in FIGS. 4 and 5 relates to the intermediate vessel 2 which, in this case, is housed removably in a freely sliding manner in the inlet opening of the boiler 1 and is not provided with the container 9 for the coffee powder, but has an evenly perforated plate 36 on which the coffee powder is placed directly. The seal 7 has an axial edge 37 extending inside the cylindrical portion 2a of the second vessel 2 and ending with an enlargement 37a which engages in a groove 38 formed on the wall of the cylindrical portion 2a. In this way engaging of the enlarged portion 37a in the groove 38 makes the cylindrical portion 2a integral with the seal 7 and therefore, by removing the disk 4, the intermediate vessel 2 is also extracted simultaneously from the boiler 1 with its content of used coffee powder. Once extracted from the boiler 2, it is easy to separate the intermediate vessel 2 from the seal 7 by a slight traction, in order to proceed subsequently with its emptying and washing. In addition to allowing easy removal of the intermediate vessel, with this solution too the leakage of liquid mixed with coffee powder is avoided when unscrewing the disk-shaped body 4 due to the vacuum created by raising of the intermediate vessel 2.

FIG. 6 illustrates an example of coupling connection joint which allows the boiler 1 to be separated from the body 21 whenever required, for example for cleaning of the boiler, and which can be used as an alternative to a fixed coupling. In this case on the bottom wall 39 of the boiler a valve 40 is provided which intercepts the exit of a tubular element 41, at the entrance whereof the discharge duct 30 of the pump is connected and which is fixed thereon by means of a tightening screw nut 42 screwed to the body of the tubular element 41. The latter is attached, for example screwed, to the raised portion 23 of the base 21 in a special housing 23a formed thereon. The tubular element 41 is tightly coupled in a housing 43 formed on the base 39 at the valve 40.

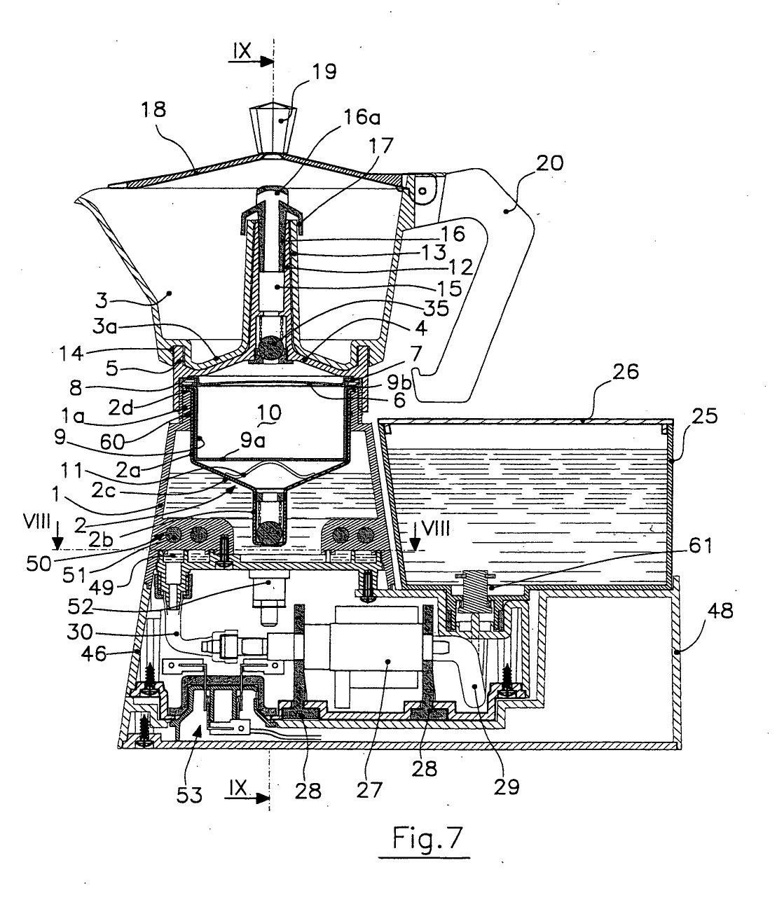

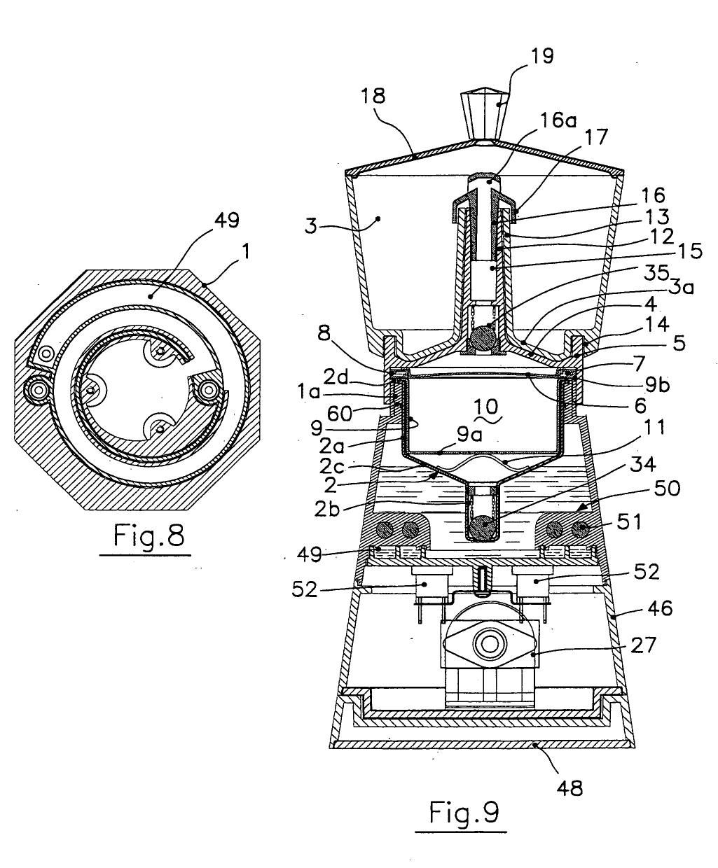

FIGS. 7, 8 and 9 illustrate a second embodiment of the coffee maker according to the invention wherein components identical to those present in the first embodiment previously described and illustrated have the same reference numerals. In this embodiment of the invention the pump 27 is housed in a box-shaped body 46 integral with the lower vessel 1 and rests on a base 48 on which the reservoir 25 also rests. The pump 27 is mounted on vibration-preventing supports 28 and is connected to the reservoir 25 via a suction duct 29 and to the boiler 1 via a discharge duct 30. The discharge duct 30, in the present embodiment of the invention, flows into a spiral path 49 formed on the base of the boiler 1, which can be seen in particular in FIG. 8, and forming part of a known and so-called “Thermoblock” device, denoted by 50, formed by armoured and co-moulded resistors 51 embedded in the metal of the boiler 1 and extending above the spiral path 49. A pair of thermostats 52 are provided on the base of the boiler 1 to control the temperature of the water which in this case reaches almost instantaneously its optimal value while passing in the spiral duct 49 and then the production of coffee can begin automatically once the boiler 1 is filled.

A rapid electrical connection, generally indicated at 53 in FIG. 7, known commercially by the name STRIX, which, since it is well known in the sector of small electric household appliances, is not illustrated in further detail.

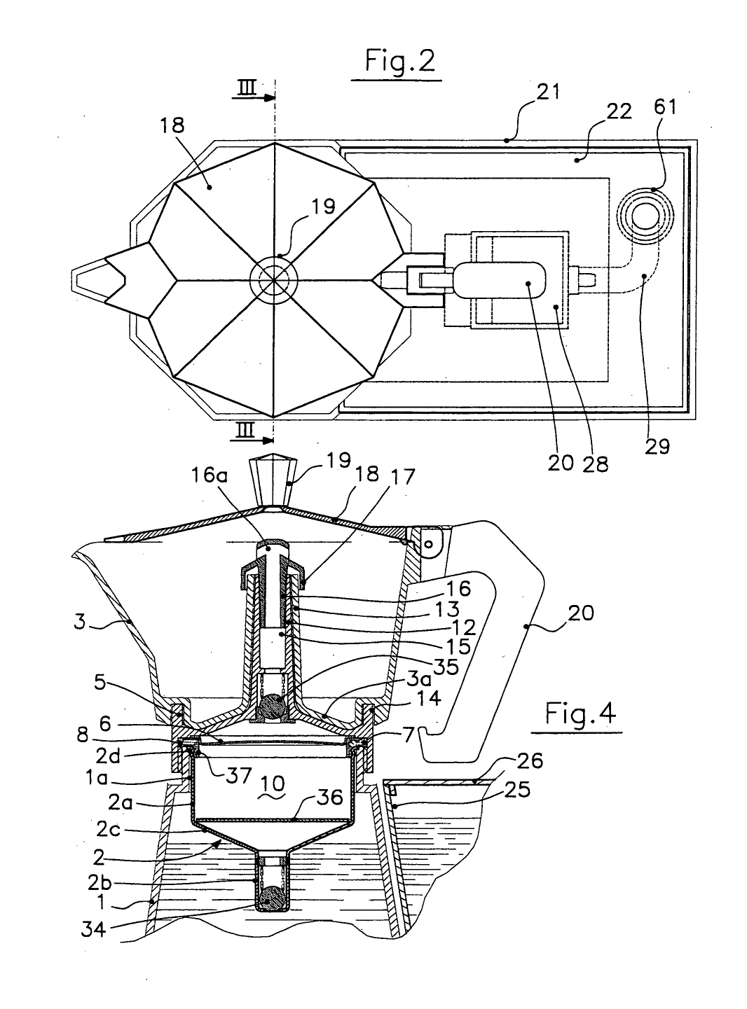

Compared to the embodiment shown in FIGS. 2-3, in this case the actual coffee maker with associated box-shaped body 46 can be separated from the reservoir 25 and from the base 48 whenever necessary, for example in order to remove the used coffee powder, allowing performance of the operation for example over the sink in order not to soil the worktop with sprays of water which inevitably come out of the boiler when it is separated from the disk 4.

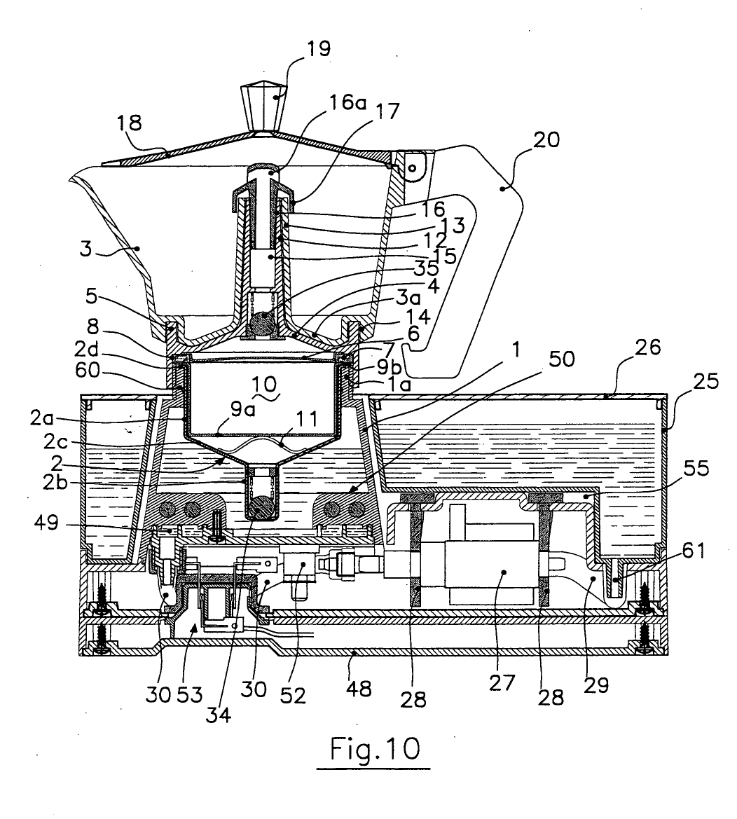

In the embodiment illustrated in FIG. 10, the pump 27 for feeding water to the boiler 1 is housed in a cavity 55 formed in the lower part of the water reservoir 25 and its suction and discharge ducts 29 and 30 are connected in a fixed manner to the reservoir 25 and to the boiler 1 respectively. The base 48 contains only the electrical part of the appliance and the electrical connector 53, of the STRIX type, and can be separated from the rest of the appliance. In this solution the reservoir 25 surrounds the boiler 1, in this way recovering the volume lost due to the cavity 55.

The heating device provided in one of the embodiments described and illustrated above can alternatively be used also in the other embodiments, and different heating devices and means from those illustrated can be used, provided they are functionally equivalent. The same applies for the valves illustrated only by way of an example.

Variants and/or modifications may be made to the coffee maker for domestic use for making espresso coffee according to the present invention without thereby departing from the scope and spirit of the invention as set forth in the following claims.

1. An apparatus for making espresso coffee and the like, comprising: a lower vessel with an inlet opening and an intermediate vessel having a substantially funnel shape positioned axially in the lower vessel, the lower vessel being associated with an electric heater for heating water contained in the vessel, the intermediate vessel comprising at least one perforated plate that defines a containment chamber for coffee in a finely ground or powder form; an upper vessel mounted axially and removably to the lower vessel and in communication with the latter via the intermediate vessel; a sealing arrangement for reversibly and relatively tightly connecting the outside of the intermediate vessel to the lower vessel, wherein the lower vessel is hydraulically connected to a water reservoir via a pump; the reservoir being positioned alongside the lower vessel and on the same support, the water being fed into the lower vessel near the electric heater, at least one valve being provided for controlling the pressure of the heated water and/or of the coffee produced such that dispensing of the coffee in the upper vessel occurs only when the water/coffee pressure reaches a predetermined value.

2. The apparatus set forth in claim 1, wherein the watertight sealing arrangement comprises a disk-shaped body above the intermediate vessel bordered by a perimetric sleeve integral thereto and which can be reversibly connected to the lower vessel, the disk-shaped body being provided with an annular seal which is tightened against the lower vessel when the sleeve is connected to the lower vessel, the disk-shaped body also having a passage for placing the chamber in communication with the upper vessel.

3. The apparatus set forth in claim 1, wherein the watertight sealing arrangement comprises a first axial tubular element, extending in the upper vessel, which has a bottom wall wherefrom a second tubular element rises up, the second tubular element being mounted coaxially and slidingly in relation to the first tubular element, the latter communicating with the chamber of the intermediate vessel and being provided at its free end with a member for dispensing the coffee produced, suitable for creating a watertight seal between the first and second tubular elements.

4. The apparatus set forth in claim 3, wherein the dispensing member comprises a truncated cone sleeve engaged in a correspondingly flared end portion of the first tubular element and a skirt extending radially from the sleeve and placed around the end portion of the second tubular element.

5. The apparatus set forth in claim 2, wherein the inlet of the lower vessel is delimited laterally by a tubular wall and the sleeve is reversibly attached to the wall.

6. The apparatus set forth in claim 1, wherein the pump is positioned inside the support.

7. The apparatus set forth in claim 1, wherein the pump is positioned inside a box-shaped body integral with the lower vessel and removable from the support.

8. The apparatus set forth in claim 1, wherein the pump is located in a cavity formed in the water reservoir and fixedly connected to the lower vessel and to the reservoir.

9. The apparatus et forth in claim 1, wherein the intermediate vessel is removably and relatively tightly connected to the lower vessel and houses a container having a perforated bottom for the coffee in finely ground or powder form, and removable therefrom.

10. The apparatus set forth in claim 9, wherein an elastic element is provided between the bottom of the container and the intermediate vessel and is in a relatively compressed state such that, by removing the watertight sealing arrangement, the container is forced to slide axially in relation to the intermediate vessel and to project partially therefrom.

11. The apparatus set forth in claim 9, wherein the intermediate vessel is mounted in a freely sliding manner in relation to the lower vessel and the seal integral with the watertight sealing arrangement has an axial annular appendage extending inside the intermediate vessel and having an enlarged portion which engages in an annular groove thereof, such that the intermediate vessel is made elastically integral with the watertight sealing arrangement and, when separated from the lower vessel, the intermediate vessel separates with them.

12. The apparatus set forth in claim 1, wherein the intermediate vessel comprises a tubular portion extending into the lower vessel, at least one of the valves controlling the pressure of water being located therein.

13. The apparatus set forth in claim 3, wherein the first tubular element defines an outlet duct from the chamber, wherein at least one of the valves is provided for creating a restricted section for the flow of liquid passing therethrough.

14. The apparatus set forth in claim 1, wherein the first tubular element defines an outlet duct from the chamber, the at least one valve for controlling the pressure of the coffee produced being placed therein.

15. The apparatus set forth in claim 2, wherein in the bottom wall of the upper vessel a groove is formed along a perimeter thereof for engaging the sleeve.

16. The apparatus set forth in claim 1, wherein the lower vessel is integrally connected to the pump.

17. The apparatus set forth in claim 1, wherein the lower vessel is tightly connected in a releasable manner to the pump.

18. The apparatus set forth in claim 17, wherein the releasable watertight connection comprises an on-off valve at an outlet of a sleeve that is engaged in the discharge tube of the pump, a first housing being formed on the base in which the sleeve is engaged for releasable connection to the base, and a second housing being formed on the bottom wall of the lower vessel coaxially to the first housing to house relatively tightly both the outlet end of the sleeve and the on-off valve.

19. The apparatus set forth in claim 1, wherein in the lower vessel a feed water nozzle is provided hydraulically connected to the discharge duct for feeding water generally tangentially to the base of the vessel.
